(19) United States
(12) Patent Application Publication
(10) Pub. No.: US 2011/0204005 A1
(43) Pub. Date: Aug. 25, 2011

(54) Shelving Unit for a Locker and Method

(76) Inventor: Vitor N. Freitas, Bonham, TX (US)

(21) Appl. No.: 12/711,784

(22) Filed: Feb. 24, 2010

(51) Int. Cl. A47B 81/00; E05B 65/52; A47B 96/02

(52) U.S. Cl. 211/4

(57) ABSTRACT

A shelving unit for a locker having an opening for accessing the interior of the locker is formed from a base member configured to rest on a floor of the locker. A pair of opposite upright sidewalls are each releasably coupled at a lower end to opposite sides of the base. At least one shelf member is positioned between the opposite sidewalls and is supported on a shelf support that releasable engages each sidewall. A cap member releasable couples to upper ends of the upright opposite sidewalls. An upright divider member is configured to be received between at least one of A and B, wherein A is the base member and shelf member and B is the shelf member and cap member. The upper and lower ends of the upright divider member are received within cooperating divider slots formed in at least one of A and B. The divider member is slidable within the slots formed in said at least one of A and B to facilitate positioning the divider member between at least one of A and B during assembly and disassembly. A locking member selectively engages the divider member and at least one of the shelf member and cap member to prevent slidable movement of the divider member within the slots when the divider member is positioned between A and B.

### BACKGROUND

The invention relates to shelving and storage units.

### BRIEF DESCRIPTION OF THE DRAWINGS

For a more complete understanding of the present invention, and the advantages thereof, reference is now made to the following descriptions taken in conjunction with the accompanying figures, in which:

FIG. 1 is a perspective view of a locker and a shelving unit for the locker that is constructed in accordance with the invention;

FIG. 2 is an exploded, perspective view of a base member and sidewalls of the shelving unit of FIG. 1;

FIG. 3 is a perspective view of different shelf members of the shelving unit of FIG. 1;

FIG. 4 is a top plan view of a slotted shelf member of the shelving unit of FIG. 1;

FIG. 5 is a perspective view of the shelving unit of FIG. 1, shown with an upper cap member exploded away from the shelving unit;

FIG. 6 is a perspective view of the shelving unit of FIG. 1, shown with a divider member and locking members exploded away from the shelving unit; and

FIG. 7 is perspective view of the shelving unit of FIG. 1, shown in an inverted configuration.

### DETAILED DESCRIPTION

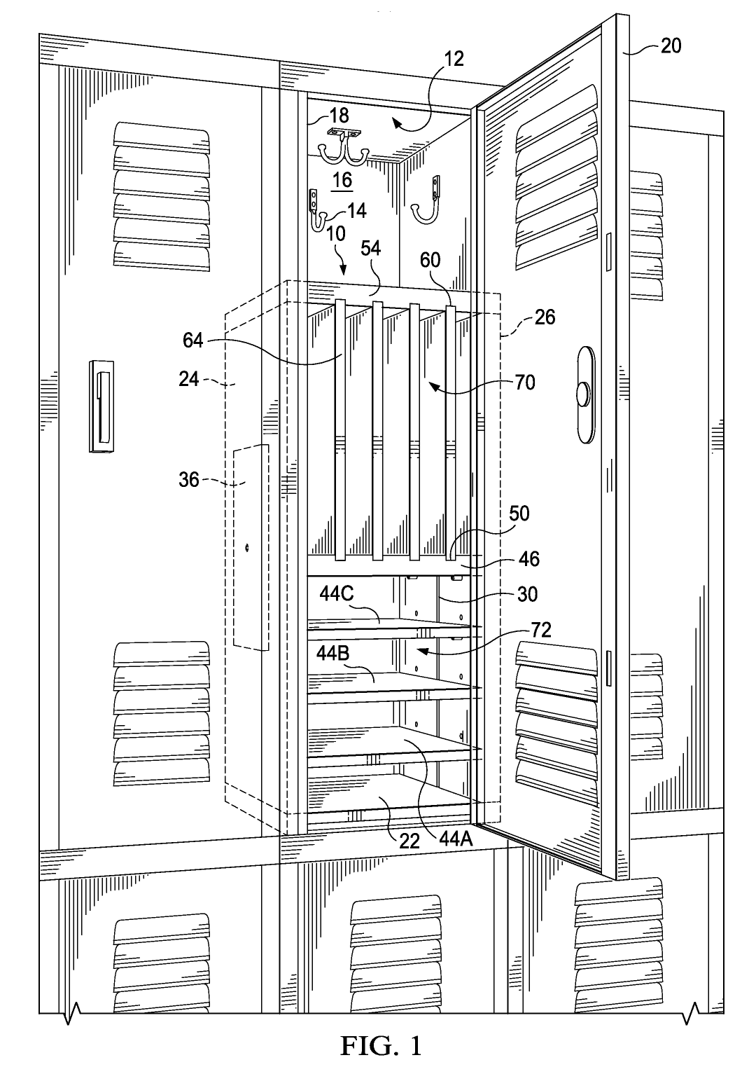

Referring to FIG. 1, a shelving unit 10 is shown that is configured for use in a preexisting locker 12. The locker 12 may be that typically used in schools, gyms, dressing rooms and other areas. In the embodiment shown in FIG. 1, the locker 12 is a locker unit of a multi-tiered locker assembly (e.g. double- or triple-tiered) wherein two or more locker units are arranged in a stacked configuration. Although the dimensions of such locker units may vary, a locker unit of a mutli-tiered locker may have generally rectangular box-shaped interior and have a height of from about 12 inches to about 40 inches or more, a width of from about 10 to about 18 inches, and a depth of from about 10 to about 18 inches. In other embodiments, the shelving unit 10 may be sized and configured for use in a single-tiered locker unit, which may have a similar width and depth but have a height of from about 40 inches to about 72 inches or more.

It should be understood that with respect to any amount range listed or described herein as being useful, suitable, or the like, it is intended to include every amount or number within the range, including the end points, and is to be considered as having been specifically stated. For example, “a range of from 1 to 10” is to be read as indicating each and every possible number along the continuum between about 1 and about 10. Thus, even if specific points within the range, or even no points within the range, are explicitly identified or refer to only a specific few, it is to be understood that the inventor appreciates and understands that any and all points within the range are to be considered to have been specified, and that the inventor is in possession of the entire range and all points within the range.

Hooks 14 or other structures may project within the interior of the locker 12 at its upper portion. The shelving unit 10 may be sized to provide a clearance 16 for these existing structures located at the upper end of the locker so that the shelving unit 10 does not interfere or require their removal. Additionally, the shelving unit 10 may be sized and/or configured to accommodate any existing screws, bolts or other fasteners that project at various areas within the interior of the locker 12, such as in the corners of the locker unit 12. In other embodiments, the shelving unit 10 may generally fill the entire interior of the locker unit 12. In such cases, any existing hooks 14 or other structures may be removed prior to installation of the shelving unit 10.

The front of the locker 12 is provided with an opening 18 for accessing the enclosed interior of the locker 12. A locker door 20 is provided with the locker 12 for selectively closing the opening 18. As can be seen in FIG. 1, the width and/or height of the opening 18 may be less than the width and height of the locker interior so that an inwardly projecting lip or frame may be defined around the opening 18 along one or more sides. In the embodiment shown, an inwardly projecting lip is provided along the upright sides of the opening 18 that each project from about ¼ inch to 1 inch or more so that the opening width is less than the interior width.

In certain embodiments, the shelving unit 10 may be provided with a width and/or height that is greater than the width and/or height of the opening 18 but less than the width and/or height of the locker interior. In such cases, the shelving unit 10 is constructed so that it can be passed through the opening in a broken down or disassembled state and installed or assembled within the locker interior. In other embodiments, the shelving unit 10 may have a width and/or height that is less than that of the opening so that the shelving unit 10 can be passed through the opening 18 in a preassembled state. As shown in FIG. 1, when the shelving unit 10 is assembled within the interior of the locker 12, the sides of the shelving unit 10 may overlap the frame or lip surrounding the opening 18 so that the shelving unit 10 cannot be removed from the locker 12 without breaking down or disassembling the shelving unit 10.

Referring now to the remaining figures, the shelving unit 10 and its components will be described. The various components of the shelving unit 10 may be formed from wood, plastic, metal, fiberglass, composites or other suitable materials that facilitate its use and construction as described herein. The following discussion also generally describes its assembly, wherein components of the unit 10 may be installed within a locker unit with an opening that does not facilitate passage of a preassembled shelving unit. In other embodiments, the shelving unit 10 may be assembled in a similar fashion and positioned within a locker where the size and shape facilitate passage of the preassembled shelving unit through the locker opening. In still other embodiments, the shelving unit 10 may be used as a freestanding shelving unit that is not utilized with any locker. In such cases, the shelving unit 10 may be supported on the floor or a support surface. Additionally, the shelving unit 10 may be mounted to a wall or other non-locker structure.

The shelving unit 10 is provided with a base member 22. The base member 22 may be a flat square or rectangular member or panel that is configured for resting on a floor of the locker unit 12. Other configurations for the base member 22 may also be provided. When assembling the shelving unit 10, the base 22 may be initially passed through the opening 18 of the locker by initially tilting or angling the member 22 to a non-horizontal position and then positioning the member 22 so that it rests on the floor of the locker 12. Additional components are then added to assemble the shelving unit 10 within the locker.

A pair of opposite sidewalls 24, 26, which may be generally flat, rectangular members or panels, releasably couple to opposite sides of the base 22. This may be accomplished through the use of short dowel rods or pins 28, which may be releasable, that are received in holes formed in the upper surface of the base 22 along its corners or edges. Corresponding holes formed in the lower end of the sidewalls 24, 26 receive the dowels or pins 28 so that the sidewalls 24, 26. In certain embodiments, the dowels or pins 28 may facilitate holding the sidewalls 24, 26 in a generally upright position without requiring additional support. Other fasteners or coupling means other than the dowel rods or pins 28 may also be used for releasably coupling the sidewalls 24, 26 to the base member 22.

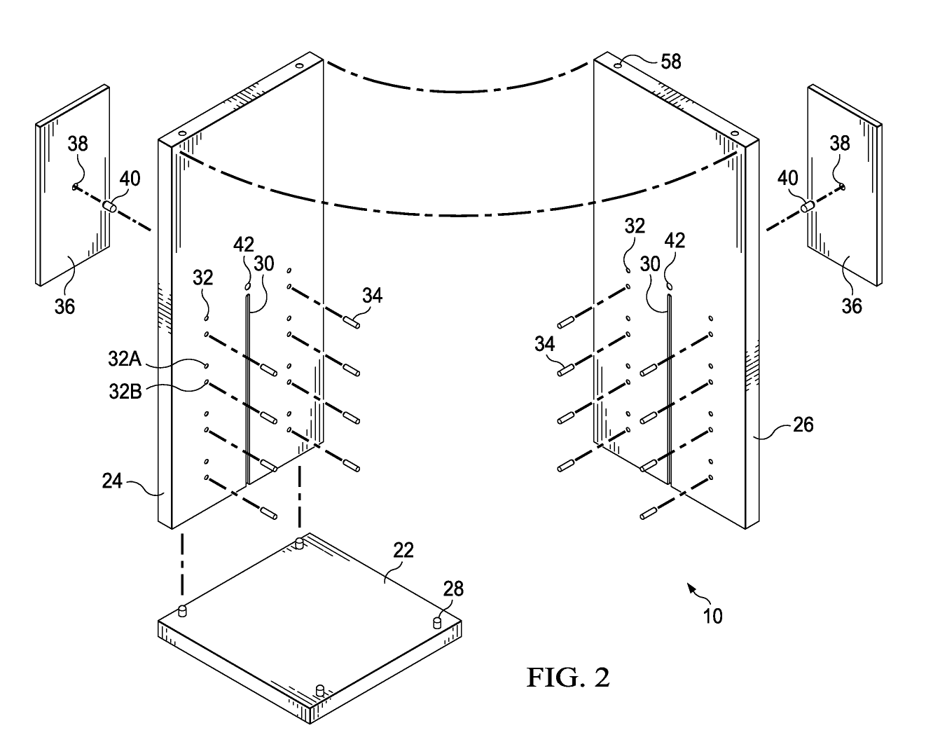

As shown in FIG. 2, a longitudinal groove 30 is formed in the inward surface through a portion of the thickness or through the entire thickness of one or both of the sidewalls 24, 26. The groove 30 may extend along the entire length (not shown) or only a portion of the length of one or both sidewalls 24, 26.

Shelf support holes or apertures 32 are formed in the inward surface of each of the sidewalls 24, 26 that are longitudinally spaced along at least a portion of the length of the sidewalls 24, 26. In certain embodiments the holes 32 may be longitudinally spaced along the entire length of the sidewalls 24, 26. The holes or apertures 32 are configured to receive a rod or pin or other structure of a shelf support 34. The entire shelf support 34 may be configured as a pin or rod that is received in the end of the holes 32, with a portion of the pin projecting from the hole 32 serving as the shelf support. In other embodiments, a flat tab or other shelf support structure may project from the pin that is received within the hole 32 so that the projecting portion is configured for receiving and supporting a shelf, as is described later on. On each sidewall 24, 26, the holes 32 are arranged in horizontally aligned pairs (one towards the front and one towards the rear of the sidewall) that are positioned at a height to correspond to similarly configured holes 32 located on the opposite sidewall. Additionally, in the embodiment shown, the holes or apertures 32 may be vertically arranged or configured in longitudinally spaced apart vertical pairs, as at 32A, 32B, that allow adjustment of the position of the pins 34, such as when the shelving unit 10 is inverted, as is described later on. In the configuration shown, the shelf supports 34 are received within the lowermost hole 32B of the vertical hole pairs 32A, 32B.

A spacer member 36 may be provided with one or both of the sidewalls 24, 26. The spacer 36 may be configured as a flat member, panel or other structure that releasably couples to the outer surface of the sidewalls 24, 26. In the embodiment shown, a hole or aperture 38 is provided for receiving one end of a dowel or pin 40. A corresponding hole or aperture 42 formed in one or both sidewalls 24, 26 is provided for receiving the other end of the dowel or pin 40 to facilitate coupling of the spacer 36 to the sidewalls 24, 26. In the embodiment shown, the hole or aperture 42 extends through the thickness of the sidewalls 24, 26 and is located above the longitudinal groove 30, although it may be located to one side of the groove 30. In certain embodiments, the hole 42 may only extend from the exterior surface through a portion of the thickness of the sidewalls 24, 26. Other coupling means or fasteners may be used for coupling the spacer 36 to the sidewalls. The spacer member 36 is selectively used to fill in any gap or space between the shelving unit 10 and the sidewalls of the locker 12 to prevent or limit lateral movement of the shelving unit 10 within the interior of the locker 12. In certain embodiments no spacer may be provided. The spacer members 36 may be coupled to the sidewalls 24, 26 prior to the sidewalls 24, 26 being coupled to the base 22.

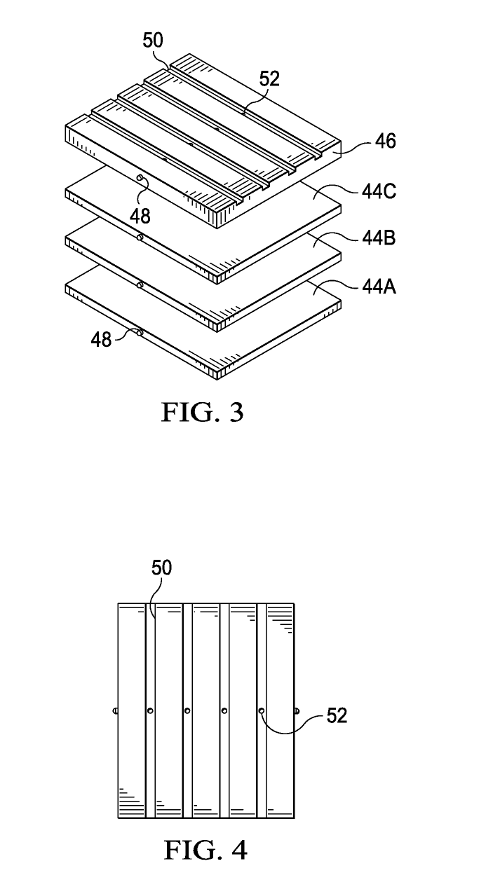

Referring to FIG. 3, shelf members 44A, 44B, 44C and 46 are shown. Each of the shelf member 44A-44C and 46 are formed as generally flat panels that are sized and configured to be received between the sidewalls 24, 26 and supported on the shelf supports 34. The members 44A-44C and 46 are generally flat members and are oriented in substantially level horizontal positions or planes when supported on the shelf supports 34. The vertical spacing between each adjacent shelf 44A-44C and 46 may be from about for 1½ inches or less to 3, 4, 5, 6 inches or more, although this distance may vary depending upon the configuration and length of the shelving unit 10 and the number shelves provided. The number of shelf members may vary from one or more. In the embodiment shown there are four shelf members with the base 22 serving as a bottom shelf.

Provided in one or both side edges of each shelf member 44A-44C and 46 is a projecting member 48 that is configured to cooperate and be received within the longitudinal groove(s) 30 of the sidewalls 24, 26. In the embodiment shown, the projecting member 48 is in the form of a pin or dowel that may be releasably or non-releasably coupled to the shelf member. In assembling the shelving unit 10, each shelf member 44A-44C and 46 is inserted between the sidewalls 24, 26 one at a time. Initially, it may be necessary to angle the shelf members 44A-44C and 46 slightly from a horizontal position during assembly to provide a clearance for the projecting members 48. When the projecting member 48 of each shelf member is aligned with the groove(s) 30, the shelf members 44A-44C and 46 may be rotated to the horizontal position so that the shelf members 44A-44C and 46 engage and rest on the shelf supports 34 in a generally horizontal position or plane. It should be noted that in certain embodiments, some or all of the shelf members may be oriented in a non-horizontal position or planes. Thus, for example, the shelf members may be angled downward to the left or to the right or from front to back. In such cases the location of the holes 32 and supports 34 may be configured differently to effect such non-horizontal position.

Additionally, while the projecting member 48 is provided on the shelf members, in other embodiments, instead of a longitudinal groove 30 being formed in each sidewall 24, 26, the sidewalls 24, 26 may be provide with a projecting portion, lip or member and the edges of the shelving units 44A-44C may be provided with a corresponding groove or recess for receiving such projecting portion of the sidewalls 24, 26.

As can be seen in FIG. 4, the shelf member 46 constitutes an uppermost shelf member 46 and is provided with one or more transversely spaced apart parallel slots or grooves 50 formed in the upper surface that extend through a portion of the thickness of the shelf member 46. The slots 50 extend from the forward end of the shelf member 46 towards the rearward end and may extend across a portion or the entire surface of the shelf member 46 from front to back. Provided in each slot 50 is one or more apertures or holes 52 that extend through the thickness of the slot 50 and communicate with the lower surface of the shelf member 46. In the embodiment shown, there is a single hole 52 provided within each slot that is located generally midway along the length of the slot 50. The hole 52 or holes may be located at different positions, however.

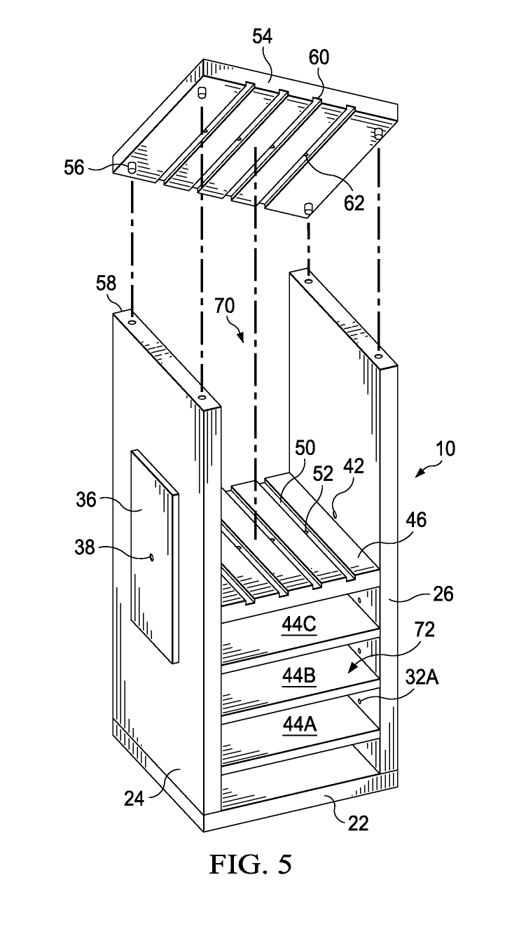

Referring to FIG. 5, a cap member 54 is provided with the shelving unit 10. The cap member 54 is a generally flat square or rectangular member or panel that is configured for resting on the upper ends of the sidewalls 24, 26. Other configurations for the cap member 54 may also be provided. The cap member 54 may have similar dimensions to those of the base 22. When assembling the shelving unit 10 within the locker 12, the cap member 54 may also be initially passed through the opening 18 of the locker by tilting or angling the member 54 to a non-horizontal position and repositioning the member 54 so that it rests on the upper ends of the sidewalls 24, 26, which may be located in a generally horizontal plane.

The cap member 54 is releasably coupled to the upper ends of the sidewalls 24, 26 through the use of short dowels or pins 56 that are releasably or non-releasably received in holes formed in the lower surface of the cap 54 along its corners or edges. Corresponding holes 58 formed in the upper end of the sidewalls 24, 26 releasably receive the dowels or pins 56 so that the cap 54 is securely fastened to the sidewalls 24, 26 when positioned thereon. This also facilitates holding the sidewalls 24, 26 in place. Other fasteners other than the dowel rods or pins 54 may also be used for releasably coupling the cap 54 to the sidewalls 24, 26. In certain cases, the cap member 54 may be coupled to the sidewalls 24, 26 prior to assembling the shelves 44A-44C, 46 and dividers 64 to facilitate stabilization the sidewalls 24, 26 during assembly.

As shown in FIG. 5, the lower surface of the cap member 54 is provided with one or more transversely spaced apart parallel slots or grooves 60 formed that extend through a portion of the thickness of the cap member 54. The slots 60 extend from the forward end of the cap member 54 towards the rearward end and may extend across a portion or across the entire lower surface of the cap member 54. Additionally, each of the slots 60 is oriented and spaced so that it is vertically aligned with and cooperates with a corresponding slot 50 of the shelf member 46. Provided in each slot 60 is one or more apertures or holes 62 that extend through the thickness of the slots 60 and communicate with the upper surface of the cap member 54. In the embodiment shown, there is a single hole 62 provided within each slot 60 that is located generally midway along the length of the slot 60. The hole 62 or holes may be located at different positions, however.

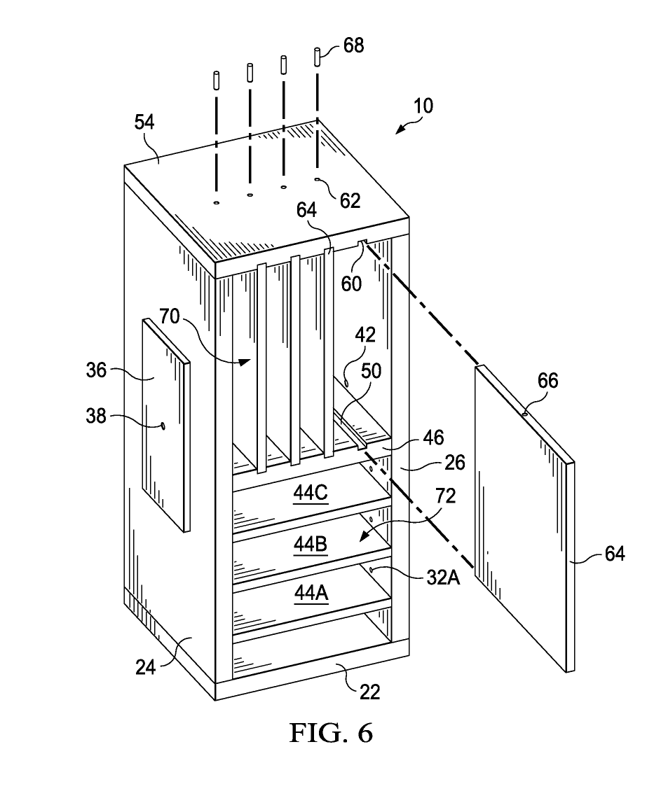

Referring to FIG. 6, one or more divider members 64 are provided with the shelving unit 10. Each divider member 64 may be formed a flat square or rectangular panel that is sized and configured for being received within the slots 50, 60 formed in the shelf 46 and cap member 54, respectively. In this way, the divider members 64 can be slid into the slots formed in the shelf member 46 and cap member 54 and are held in generally upright manner between the shelf 46 and cap 54. Additionally, the slots 50, 60 are of sufficient depth to prevent lateral movement of the dividers 64. The width of the slots 50, 60 may be such that any of lateral movement of the dividers 64 within the slots 50, 60 is limited or prevented. In the embodiment shown, there are four dividers 64 that are equally spaced apart. The dividers may be laterally spaced apart to provide divider storage spaces having a width of from about one inch or less to about 1½ inch, 2 inches, 3 inches, 4 inches or more.

A hole or aperture 66 is formed in one or both ends of each divider 64, as shown. When the divider members 64 are fully inserted within the slots between the shelf 46 and cap 54, the holes 62 of the cap member 54 will align with the holes or apertures 66 of the divider members 64. Locking members 68, which may be in the form of dowels or pins, may be inserted into the holes 62 of the cap member 54 and into the aligned hole or aperture 66 of the divider 64. The locking member 68 thus selectively engages the divider 64 and prevents forward and rearward movement of the divider 64 within the slots 50, 60. Other configurations for the locking members 68 may also be used.

With the shelving unit 10 fully assembled within the locker 12, the shelving unit 10 provides a convenient and organized means for storing items, such as folders, papers, books, laptops, etc., within the locker 12. The storage spaces formed by the shelves and dividers may be sized and configured for receiving typical folders and books that may be stored in lockers. Thus, the shelves or divider storage spaces may have a height or width of from about 8, 9 or 10 inches or less to about 11, 12, 13 inches or more. The shelving unit 10 is structurally sound and stable when fully assembled and cannot be readily removed from the locker 12 without disassembly in cases where the opening 18 of the locker 12 is smaller than the shelving unit 10.

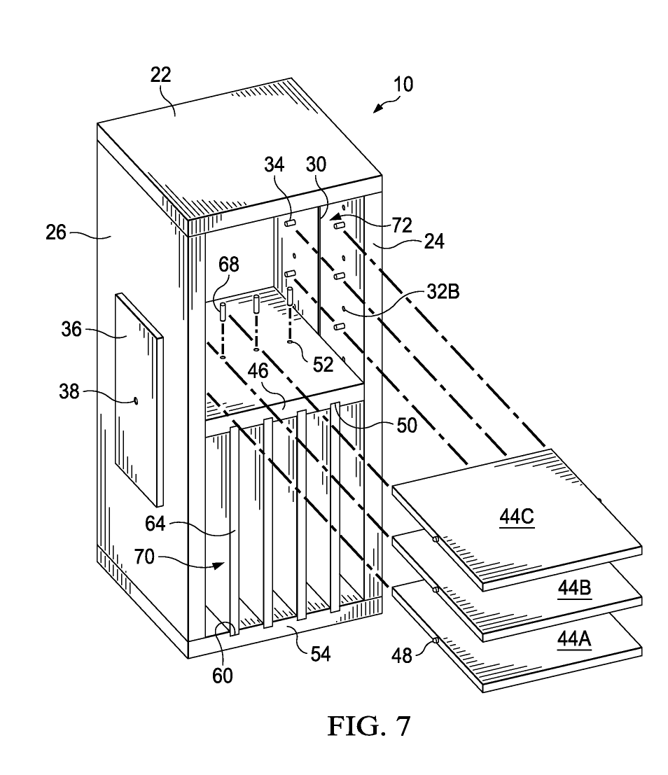

Referring to FIG. 7, the shelving unit 10 is shown in an inverted configuration and mode of operation. In this configuration, the divider section 70 is located at the lower end of the shelving unit and the horizontal shelf section 72 is at the upper end. In this configuration, the assembly of the shelving unit 10 is similar to that previously described with some modifications. In the inverted configuration, the cap member 54 forms the lower base of the shelving unit 10, with the member 54 being positioned on the locker floor or other support structure. The sidewalls 24, 26 are inverted and coupled to the inverted cap member 54 through the dowels or pins 56 and held in an upright manner.

To provide the desired shelf spacing, if necessary, the shelf supports 34 may be positioned in the holes 32A, which now constitute the lower holes of the vertical hole pairs 32A, 32B (FIG. 1). The shelf 46 is inserted between the sidewalls 24, 26 with the projecting member 48 being received within the groove(s) 30 of the sidewall 24 and/or 26 so that the shelf 46 rest on the supports 34. As can be seen in FIG. 7, the shelf 46 forms the lowermost shelf and is inverted so that the slots 50 are oriented downward. The dividers 64 are then inserted between the shelf 46 and the member 54, which now forms the base of the shelving unit 10. When the dividers 64 are fully inserted within the slots 50, 60, the locking pins 68 may be inserted into the holes 52 of the shelf member 46 and into locking engagement with the hole or aperture 66 (FIG. 6) of the divider member 64 to lock the dividers 64 in place. The shelves 44A-44C may then be inserted between the sidewalls 24, 26 with the projecting members 48 being received within the groove(s) 30 of the sidewalls 24, 26 and supported on the shelf supports 34 in a horizontal position. The base member 22 may then be added. The base 22 now forms the cap of the shelving unit 10 and is coupled to the ends of the sidewalls 24, 26 through the dowels or pins 28 (FIG. 1). The base member 22 may also be added prior to installing the shelves and divider members to facilitate stabilization of the sidewalls 24, 26, if desired.

The shelving unit 10 may be provided as a kit that can be assembled and/or disassembled without requiring any tools. In certain instances, less than all of the shelves or dividers supplied with the shelving unit 10 may be used as desired. The shelving unit 10 may be disassembled in either mode by removing each component in turn in a generally reverse order to that of its assembly.

In alternate embodiments, the shelving unit may include or be assembled with only the horizontal shelves or the upright divider members, but be constructed in a similar manner. In such cases, the shelving unit may be smaller in size or the same size as that including both divider and shelving sections 70, 72. More or fewer dividers or shelves may be provided in such instances. Additionally, the shelving unit may be configured as a modular unit, wherein one shelving unit may be stacked and/or coupled to another. In such instances, releasable coupling means (such as holes formed in the upper or lower surfaces of the cap member and base, respectively, and dowels or pins received within such holes) may be used to releasably couple the modular shelving units together.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

I claim:

1. A shelving unit for a locker having an opening for accessing the interior of the locker, the shelving unit comprising:
a base member configured to rest on a floor of the locker;
a pair of opposite upright sidewalls that each releasably couple at a lower end to opposite sides of the base;
at least one shelf member;
a shelf support that releasable engages each sidewall for supporting the at least one shelf member when the shelf member is positioned between the opposite sidewalls;
a cap member that releasable couples to upper ends of the upright opposite sidewalls;
an upright divider member configured to be received between at least one of A and B, wherein A is the base member and shelf member and B is the shelf member and cap member, the upper and lower ends of the upright divider member being received within cooperating divider slots formed in at least one of A and B, the divider member being slidable within the slots formed in said at least one of A and B to facilitate positioning the divider member between at least one of A and B during assembly and disassembly; and
a locking member that selectively engages the divider member and at least one of the shelf member and cap member to prevent slidable movement of the divider member within the slots when the divider member is positioned between A and B.

2. The shelving unit of claim 1, wherein:
the shelving unit is invertible so that the cap member serves as the base member and the base member serves as the cap member.

3. The shelving unit of claim 1, further comprising:
at least one spacer member coupled to at least one of the upright sidewalls.

4. The shelving unit of claim 1, wherein:
a shelf support releasable engages each sidewall at selected positions to facilitate adjusting the support height of the shelf member.

5. The shelving unit of claim 1, wherein:
there are at least two shelf members and at least two divider members.

6. The shelving unit of claim 1, wherein:
the shelf member and at least one of the sidewalls have one of a projecting member and cooperating groove, the projecting member being received within the cooperating groove to prevent forward and rearward movement of the at least one shelf between the opposite sidewalls when the shelf member rests on the shelf support.

7. The shelving unit of claim 6, wherein:
the groove is provided with the at least one sidewall and the projecting member is provided with the shelf member.

8. The shelving unit of claim 1, wherein:
the locking member is a pin that is removably received within holes formed in the divider member and at least one of the shelf member and cap member.

9. A shelving unit for a locker having an opening for accessing the interior of the locker, the shelving unit comprising:
a base member configured to rest on a floor of the locker;
a pair of opposite upright sidewalls that each releasably couple at a lower end to opposite sides of the base;
at least one shelf member, the shelf member and at least one of the sidewalls having one of a projecting member and cooperating groove;
a shelf support that releasable engages each sidewall for supporting the at least one shelf member when the shelf member is positioned between the opposite sidewalls, the projecting member being received within cooperating groove to prevent forward and rearward movement of the at least one shelf member between the opposite sidewalls when resting on the shelf support;
a cap member that releasable couples to upper ends of the upright opposite sidewalls;
an upright divider member configured to be received between at least one of A and B, wherein A is the base member and shelf member and B is the shelf member and cap member, the upper and lower ends of the upright divider member being received within cooperating divider slots formed in at least one of A and B, the divider member being slidable within the slots formed in said at least one of A and B to facilitate positioning the divider member between at least one of A and B during assembly and disassembly; and
a locking member that selectively engages the divider member and at least one of the shelf member and cap member to prevent slidable movement of the divider member within the slots when the divider member is positioned between A and B.

10. The shelving unit of claim 9, wherein:
the shelving unit is invertible so that the cap member serves as the base member and the base member serves as the cap member.

11. The shelving unit of claim 9, further comprising:
at least one spacer member coupled to at least one of the upright sidewalls.

12. The shelving unit of claim 9, wherein:
a shelf support releasable engages each sidewall at selected positions to facilitate adjusting the support height of the shelf member.

13. The shelving unit of claim 9, wherein:
there are at least two shelf members and at least two divider members.

14. The shelving unit of claim 9, wherein:
the groove is provided with the at least one sidewall and the projecting member is provided with the shelf member.

15. The shelving unit of claim 9, wherein:
the locking member is a pin that is removably received within holes formed in the divider member and at least one of the shelf member and cap member.

15. A method of providing shelving unit within a locker having an opening that is selectively closable with a locker door, the width of the locker opening being less than the width of the interior of the locker, the method comprising:
providing a base member of the shelving unit having a width that is greater than the width of the locker opening and less than the width of locker interior, the base member being configured to rest on a floor of the locker;
positioning the base member within the interior of the locker so that the base member rests on the locker floor;
positioning a pair of opposite sidewalls of the shelving unit within the locker interior, the opposite upright sidewalls each releasably coupling at a lower end to opposite sides of the base so that the opposite sidewalls are held in an upright position;
positioning at least one shelf member between the sidewalls on a shelf support that releasable engages each sidewall of the shelving unit for supporting the at least one shelf member;
positioning a cap member that releasable couples to upper ends of the upright opposite sidewalls;
inserting an upright divider member between at least one of A and B, wherein A is the base member and shelf member and B is the shelf member and cap member, the upper and lower ends of the upright divider member being received within cooperating divider slots formed in at least one of A and B, the divider member sliding within the slots formed in said at least one of A and B when inserting the upright divider member to facilitate positioning the divider member between at least one of A and B; and
selectively engaging the divider member and at least one of the shelf member and cap member to secure the upright divider between the at least one of A and B to prevent slidable movement of the divider member within the slots when the divider member is positioned between the at least one of A and B.

16. The method of claim 15, further comprising:
coupling at least one spacer member coupled to an exterior of least one of the upright sidewalls to limit lateral movement of the shelving unit within the interior of the locker.

17. The method of claim 15, wherein:
there are at least two shelf members and at least two divider members.

18. The method of claim 15, wherein:
the shelf member and at least one of the sidewalls have one of a projecting member and cooperating groove, the projecting member being received within the cooperating groove to prevent forward and rearward movement of the at least one shelf between the opposite sidewalls when the shelf member rests on the shelf support.

19. The method of claim 18, wherein:
the groove is provided with the at least one sidewall and the projecting member is provided with the shelf member.

20. The method of claim 15, wherein:
the locking member is a pin that is removably received within holes formed in the divider member and at least one of the shelf member and cap member.
